(19) United States
(12) Patent Application Publication
(10) Pub. No.: US 2008/0231202 A1
(43) Pub. Date: Sep. 25, 2008

(54) LED Light String with Half-wave Rectifying and Filtering Device

(76) Inventor: Xuliang Li, Dongguan (CN)

Correspondence Address: GLOBAL IP SERVICES, 7285 W. Eagle Court, Winton, CA, 95388, US

(21) Appl. No.: 11/830,176

(22) Filed: Jul. 30, 2007

(30) Foreign Application Priority Data
Mar. 21, 2007 (CN) 200720119035.2

(51) Int. Cl. H05B 37/00

(52) U.S. Cl. 315/185 R

(57) ABSTRACT

The invention relates to a decorative light and more particularly, relates to an LED light string with a half-wave rectifying and filtering device. The light string includes a plug, a power line and an LED light string having a plurality of LED lamps, these LED lamps sharing the same polarization direction. The LED light string further includes a half-wave rectifying and filtering device disposed between pins of the plug and the LED light string. The light string of the invention benefits from low cost, reduced volume of itself, convenience, and a longer life span. In addition, it can be used needless of a special controller and without generating twinkling.

### CROSS REFERENCE TO RELATED PATENT APPLICATION

This patent application claims the priority of the Chinese patent application No. 200720119035.2, filing date of Mar. 21, 2007.

### FIELD OF THE INVENTION

The present invention relates to decorative lights, and more particularly relates to LED light strings having half-wave rectifying and filtering device.

### BACKGROUND OF THE INVENTION

Kinds of decorative lights are frequently used in our daily life especially on festivals for ceremony or building decoration. In these light strings, Christmas lights are used more widely. It is known that LED light can work only under direct current environment which is contrary to alternate current power existing dominantly in our routine life. In case where the LED light is driven directly by alternate current power, the LED light will suffer from twinkling, low brightness along with susceptibility to damage because of application of reverse voltage. Accordingly, a controller is usually provided to control and power the LED string. This controller, however, results in high cost, increment in volume and inconvenience.

### SUMMARY OF THE INVENTION

The invention overcomes the drawbacks of prior art described above and thus provides a LED light string incorporating a half-wave rectifying and filtering device, which benefits from low cost, reduced volume of itself, convenience, and a longer life span. In addition, it can be used needless of a special controller and without generating twinkling.

To attain the above object, a LED light string is supplied. The string includes a plug, a power line and an LED light string having a plurality of LED lamps, these LED lamps sharing the same polarization direction. The LED light string further comprises a half-wave rectifying and filtering device disposed between pins of the plug and the LED light string. The half-wave rectifying and filtering device comprises a pair of AC input ends (AC1) and (AC2), and a pair of DC output ends (OUT1) and (OUT2). The half-wave rectifying and filtering device further comprises a diode (D1) and a capacitor (C1), said diode (D1) being coupled between the AC input end (AC1) and the DC output end (OUT1), said diode (D1) sharing the same polarization direction as that of the LED lamps of the LED light string located between the DC output end (OUT1) and DC output end (OUT2). The capacitor C1 is coupled between the output end of the diode (D1) and the AC input end (AC2) connected with the DC output end (OUT2).

The half-wave rectifying and filtering device can be received inside the plug or disposed at a middle portion of the power line. The power line and the LED light string may be connected together via a connection jack in which the half-wave rectifying and filtering device is contained.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1 is functional block diagram of a circuit according to an embodiment of the present invention;

FIG. 2 shows a schematic view of a circuit according to an embodiment of the present invention;

FIG. 3 shows a schematic circuit of a half-wave rectifying and filtering device according to an embodiment of the invention;

FIG. 4 shows a waveform of an AC input power of the half-wave rectifying and filtering device according to an embodiment of the invention;

FIG. 5 shows a waveform of an DC output power of the half-wave rectifying and filtering device according to an embodiment of the invention; and

FIG. 6 shows another schematic connection circuit according to an embodiment of the invention.

### DETAILED DESCRIPTION OF ILLUSTRATED EMBODIMENTS

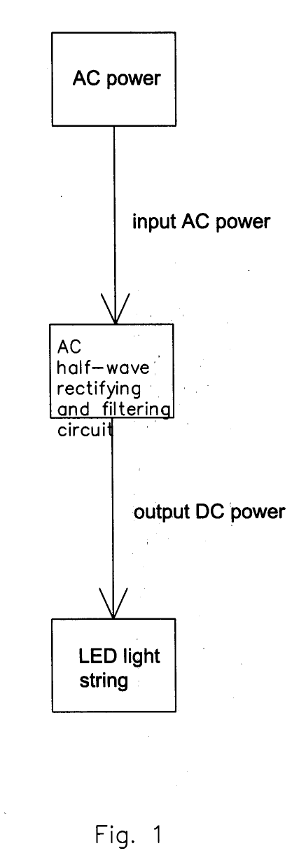

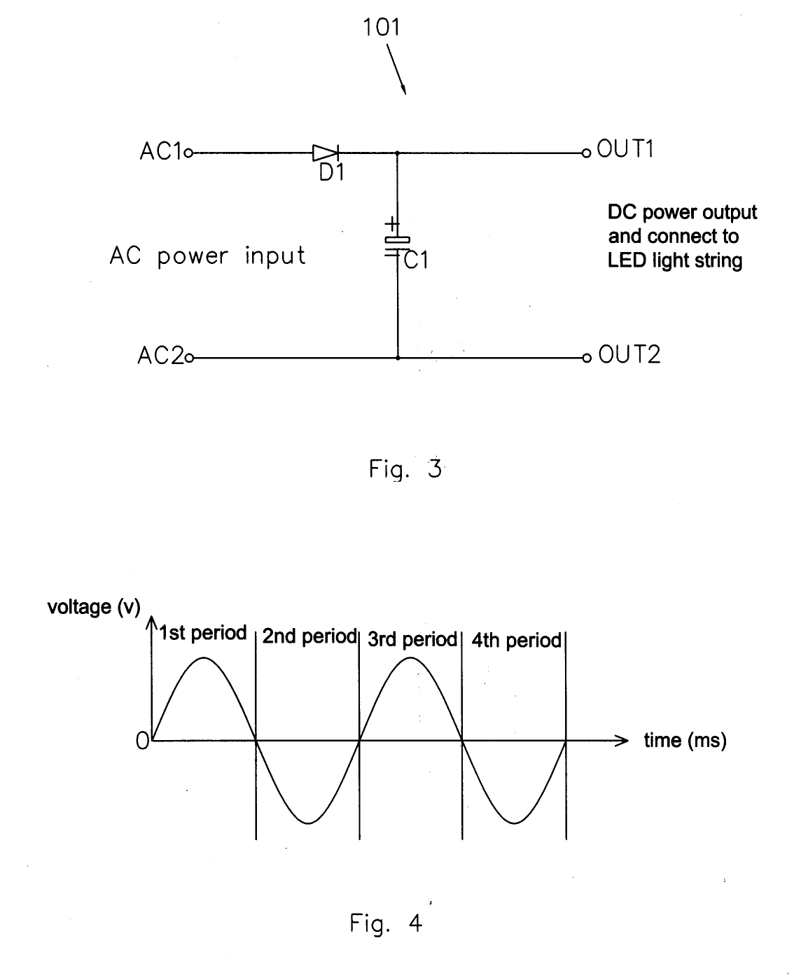

FIGS. 1-6 illustrate a first embodiment of the invention. A LED light string 10 having a half-wave rectifying and filtering device according to the embodiment comprises a plug, a power line and a LED light string 102. The LED light 102 has a plurality of LED lamps which share the same polarization direction. The LED light string 10 further comprises a half-wave rectifying and filtering device 101 disposed between pins of the plug and the LED light string 102. More specifically, the device 101 is contained in inside of the plug. As shown in FIG. 3, the half-wave rectifying and filtering device 101 includes a pair of AC input ends AC1 and AC2, and a pair of DC output ends OUT1 and OUT2. The half-wave rectifying and filtering device 101 further comprises a diode D1 and a capacitor C1. The diode D1 is coupled between the AC input end AC1 and the DC output end OUT1. The diode D1 has the same polarization direction as that of the LED lamps 1021 which are connected between the DC output end OUT1 and the DC output end OUT2. The capacitor Cl is coupled between the output end of the diode D1 and the AC input end AC2. The AC input end AC2 is connected with the DC output end OUT2.

FIG. 1 shows a functional block diagram of a circuit according to a first embodiment of the invention. As shown, an AC power block inputs alternate current into an AC half-wave rectifying and filtering circuit such that alternate current is rectified by the circuit and outputted as direct current to provide the LED strings with direct current.

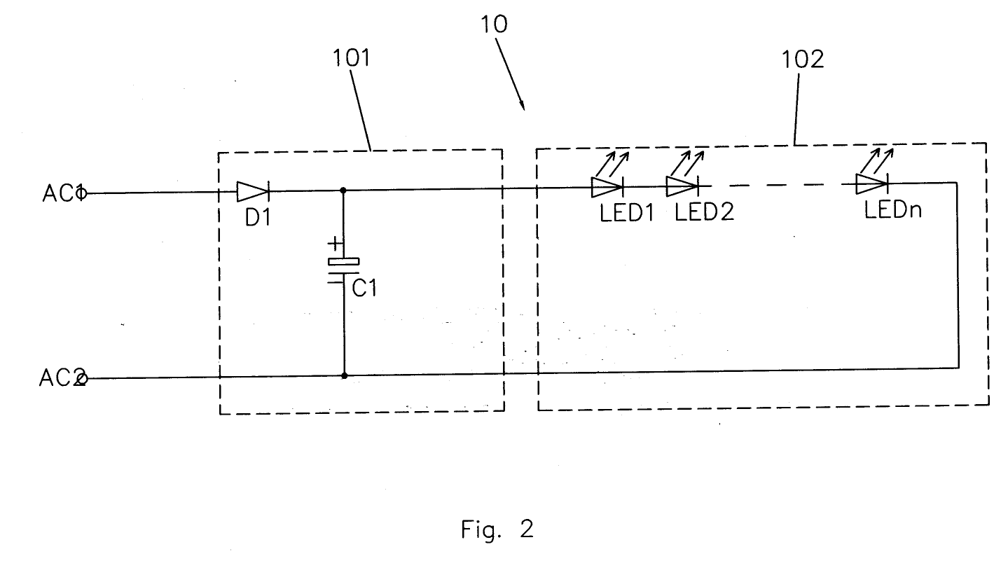

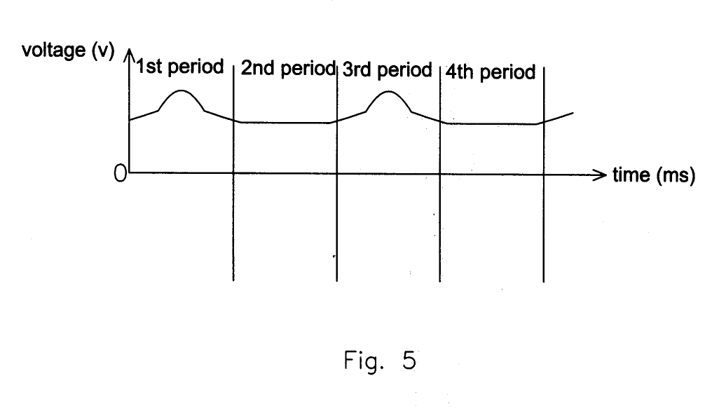

FIG. 2 shows a schematic circuit of the first embodiment of the invention. Shown at left side is an AC input portion comprising AC1 and AC2 as its AC input ends. A voltage having a waveform of sine as shown in FIG. 4 is inputted from the AC input portion. Shown at the middle is an AC half-wave rectifying and filtering circuit block 101 which converts the inputted voltage into wave-shaped voltage, as shown in FIG. 5. The LED light string 102 is shown at right side. Followed is a detailed description of operation principle of the invention. When a first time period comes, namely, when the AC1 end is positive and AC2 end is negative, alternate current is rectified by the diode D1 such that one branch current comes to and charges the capacitor C1 and then returns to the AC2, thus forming a loop circuit. After charged, the voltage applied between two electrodes of the capacitor C1 raises to maximum of the power rapidly with the upper electrode being positive and lower electrode being negative. The other branch passes through and lightens the LED light string 102 and then, returns to the AC2 end to form another loop circuit. When a second time period comes, i.e., when the AC2 is positive and AC1 is negative, the alternate current will not form a loop circuit due to reverse bias function of the diode D1. That is, the AC power is not in an electrical conduction status during the second time period. Meanwhile, the LED light string 102 is powered by discharging of the capacitor C1. In other word, electric current coming from the positive electrode passes across the LED light string 102 and finally goes to the negative electrode thereof thereby constituting a loop circuit. When comes a third time period, operation mode corresponding to the first time period repeats, and when a fourth time period comes, operation mode corresponding to the second time period is repeated. The above operation modes repeat continuously. As direct current is generated on the capacitor C1 and as the LED light string 102 is coupled to the capacitor C1 in parallel, the LED light string 102 is capable of radiating light functionally without any twinkling.

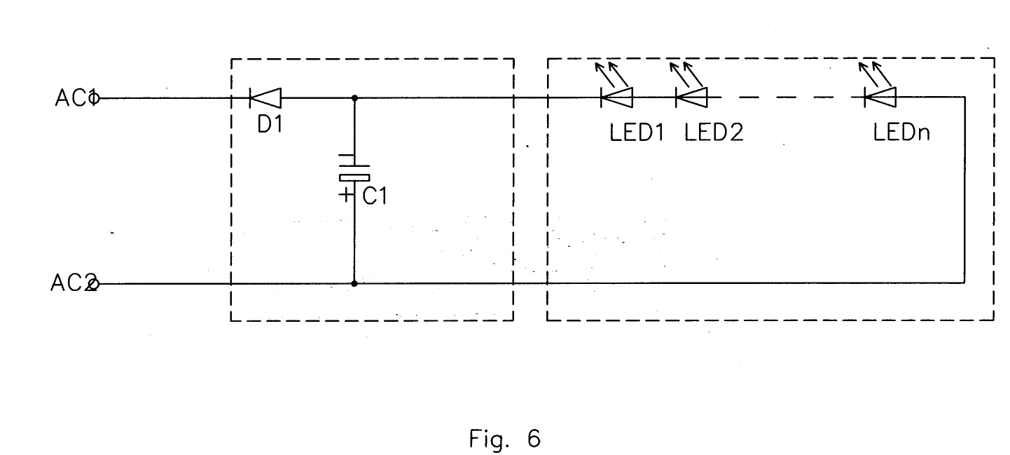

FIG. 3 illustrates a schematic circuit of a half-wave rectifying and filtering device according to an embodiment of the invention. Shown at left side is AC power input portion and shown at right side is DC output portion. The circuit of the embodiment includes a diode D1 and a capacitor C1 both of which constitute collectively a half-wave rectifying and filtering circuit. The diode D1 is a rectifier for converting alternate current to direct current, and the capacitor C1 serves to provide filtration so as to convert discontinuous direct current into continuous direct current power. FIG. 6 shows another connection of the circuit of the invention in which the diode D1 and all of the LED light lamps are arranged in an opposite direction compared to the forgoing arrangement.

A second embodiment of the invention also pertains to a LED light string with a half-wave rectifying and filtering device. The light string is different from that of the first embodiment in that the device is disposed at a middle portion of a power line and coupled with a plug and LED light string via the power line. An outer cover is coated on the outside of the half-wave rectifying and filtering device.

A third embodiment of the invention also pertains to a LED light string with a half-wave rectifying and filtering device. The light string is different from that of the first embodiment in that the power line is coupled with the LED light string via a connection jack in which the device is received.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

1. An LED light string having a half-wave rectifying and filtering device, comprising a plug, a power line and an LED light string having a plurality of LED lamps, these LED lamps sharing the same polarization direction, wherein the LED light string further comprises a half-wave rectifying and filtering device disposed between pins of the plug and the LED light string; said half-wave rectifying and filtering device comprises a pair of AC input ends (AC1) and (AC2), and a pair of DC output ends (OUT1) and (OUT2); said half-wave rectifying and filtering device further comprises a diode (D1) and a capacitor (C1), said diode (D1) being coupled between the AC input end (AC1) and the DC output end (OUT1), said diode (D1) sharing the same polarization direction as that of the LED lamps of the LED light string located between the DC output end (OUT1) and DC output end (OUT2); and the capacitor C1 is coupled between the output end of the diode (D1) and the AC input end (AC2) that is connected with the DC output end (OUT2).

2. The LED light string of claim 1, wherein the half-wave rectifying and filtering device is received inside the plug.

3. (canceled)

4. The LED light string of claim 1, wherein the power line and the LED light string are connected together via a connection jack into which the half-wave rectifying and filtering device is contained.

5. The LED light string of claim 1, wherein the half-wave rectifying and filtering device is disposed at a middle portion of the power line.

6. The LED light string of claim 2, wherein the half-wave rectifying and filtering device is disposed at a middle portion of the power line.
